(19) United States
(12) Patent Application Publication
(10) Pub. No.: US 2007/0245469 A1
(43) Pub. Date: Oct. 25, 2007

(54) Removable insulated chaps liner

(76) Inventor: Steven M. Young, Islip, NY (US)

Correspondence Address: THE FARRELL LAW FIRM, P.C., 333 EARLE OVINGTON BOULEVARD, SUITE 701, UNIONDALE, NY, 11553, US

(21) Appl. No.: 11/715,822

(22) Filed: Mar. 8, 2007

Related U.S. Application Data
(60) Provisional application No. 60/767,174, filed on Mar. 8, 2006.

(51) Int. Cl. A62B 17/00; A41D 13/02

(52) U.S. Cl. 2/458; 2/227

(57) ABSTRACT

Disclosed are a motorcycle chaps having a removable liner on each leg thereof to avoid overheating when riding on warm days, to further allow for addition of removable insulated panels, thereby providing continuous protection of a rider's legs from road hazards and injury.

### PRIORITY

This application claims priority to application Ser. No. 60/767,174, which was filed with the U.S. Patent and Trademark Office on Mar. 8, 2006, the entire contents of which is incorporated herein by reference.

### FIELD OF INVENTION

The present invention relates generally to chaps, which are outerwear garments that provide protection to the legs of a motorcycle rider.

### SUMMARY OF THE INVENTION

Present day chaps provide a wearer with protection from elements such as rain and wind, as well as stones and other road debris encountered while riding.

Chaps evolved from Chaperajos, a form of leg protection or armor invented for cowboys. Originally draped across the legs of a cowboy when riding through brush, Chaperajos were laid under the legs when not needed.

Chaperajos evolved to full-length leather britches that completely encircled a rider's legs, as a form of seat-less pants. To allow for removal without also removing boots and/or spurs, a two-piece chaps was developed having front lacing. Present day chaps cover from above just above each foot to the top of the thigh, with a belt securing the chaps at the waist of the wearer.

Motorcycle enthusiasts emulated the cowboys to enjoy the protection that chaps afford while riding. However, a pair of conventional chaps are not available with a removable insulating liner.

Accordingly, when riding on warm days, a motorcycle rider wearing conventional chaps will often feel discomfort from overheating. However, if the rider removes the conventional chaps, the rider is unprotected from road hazards and injury.

### OBJECTS OF THE PRESENT INVENTION

The present invention has proven to been to exceptionally useful, and solves the shortcomings and problems of conventional chaps. The present invention allows for attachment of a liner to an interior portion of each chap leg.

An aspect of the present invention provides a panel of insulating material attached via connectors to each leg of the chap.

The present invention provides the user with flexibility to use the chaps with or without the insulated liner for insulation and protection or for only protection, and has proven to be particularly useful on long motorcycle rides when the weather changes to require insulation at certain but not all times.

Further, the present invention allows a rider to reduce the amount of gear required on longer rides.

### BRIEF DESCRIPTION OF THE DRAWINGS

For a better understanding of the invention, as well as other objects and further features thereof, reference is made to the following detailed description to be read in conjunction with the accompanying drawings, wherein:

FIG. 1 is a rear perspective view of the chaps showing both legs with insulating liner affixed to respective legs;

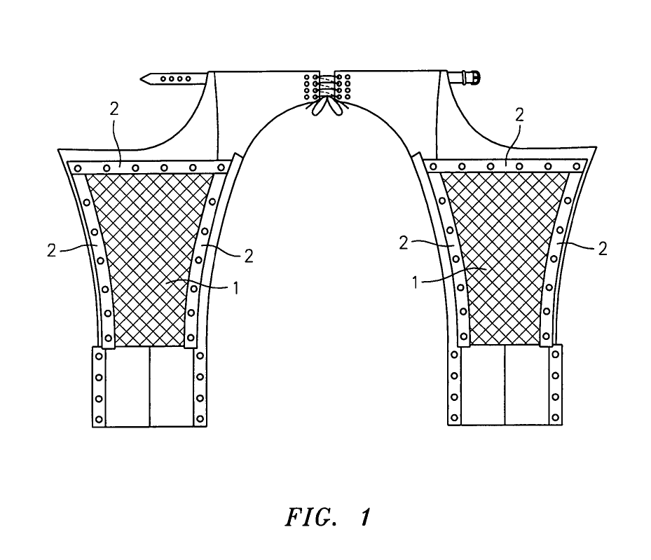

FIG. 2 is a rear perspective view of one leg of the chaps, with the insulating liner partially removed;

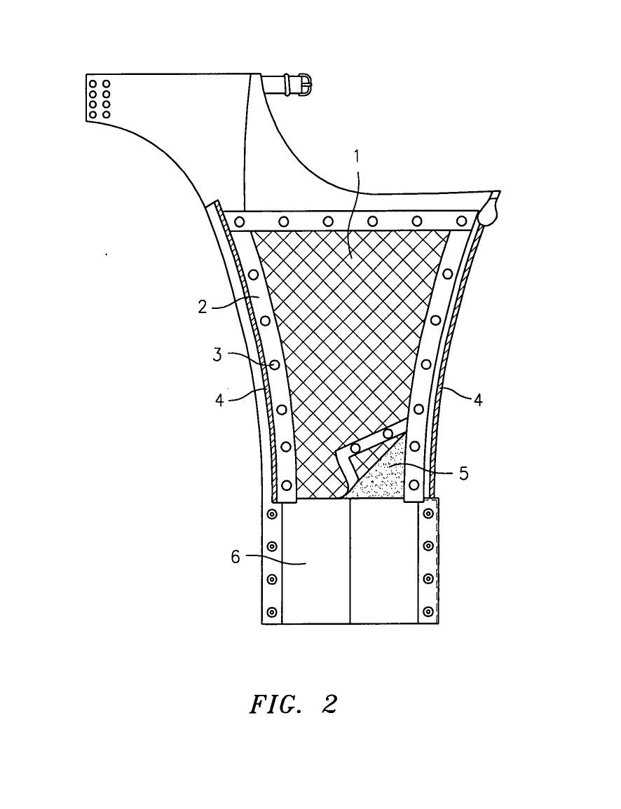

FIG. 3 illustrates connectors to affixing the insulating liner to one leg of the chaps; and

FIG. 4 shows an insulating liner removed from the chaps.

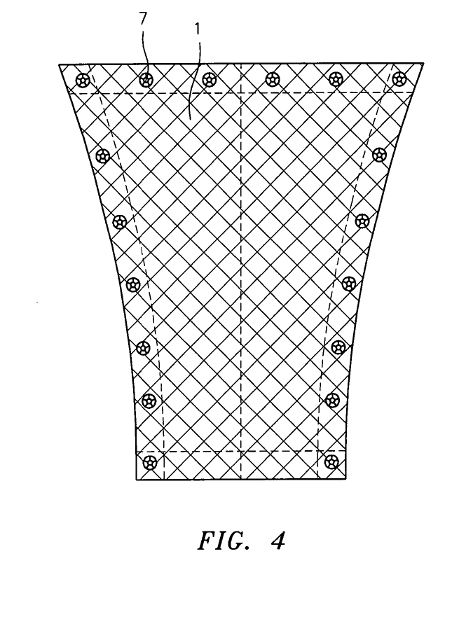

### DETAILED DESCRIPTION OF THE PREFERRED EMBODIMENTS

The following detailed description of preferred embodiments of the invention will be made with reference to the accompanying drawings. In describing the invention, explanation of related functions or constructions known in the art are omitted for the sake of clearness in understanding the concept of the invention, as such would obscure the invention with unnecessary detail.

In the present invention, a removable insulated panel 1 is provided for attachment via connectors in each respective leg of chaps worn by a motorcycle rider. The removable insulated panel 1 preferably attaches via a plurality of anchor strips 2 having connectors 3, preferably snaps, for affixing the removable insulated panel 1 on an interior surface of the chaps, adjacent to a user's thigh.

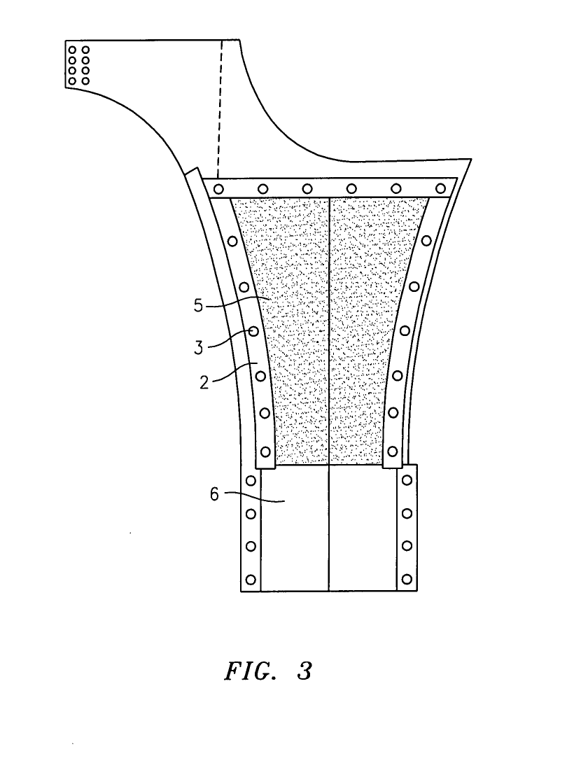

As shown in FIG. 3, a permanent sub-liner 5 is preferably provided. In addition, additional chap material 6 extends below a distal end of the permanent sub-liner 5, to cover the ankle of a taller rider. The additional chap material 6 can be cut away to fit shorter riders.

The anchor strip 2 preferably extends around a perimeter of the removable insulated panel 1, and in another embodiment extends around three out of four sides thereof.

Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed:

1. Motorcycle chaps wearable by a rider, the motorcycle chaps comprising:
a pair of legs joined at a top portion thereof at a rider's waist, wherein the legs protect the rider's legs from wind and road debris; and
a pair of insulated panels that attach at an interior part of each respectively leg, wherein each insulated panel is removable to allow use of the chaps over a wide range of weather conditions experienced while motorcycle riding.

2. The motorcycle chaps of claim 1, further comprising a plurality of connectors affixed to anchor strips.

3. The motorcycle chaps of claim 2, wherein the plurality of connectors are snaps.

4. The motorcycle chaps of claim 2, wherein each anchor strip extends around a perimeter of each respective removable insulated panel.

5. The motorcycle chaps of claim 2, wherein each anchor strip extends around a three of four sides of a perimeter of each respective removable insulated panel.

6. The motorcycle chaps of claim 1, further comprising a pair of zippers for attaching the insulated panels to each respective leg.

7. The motorcycle chaps of claim 1, further comprising additional chap material that extends in a distal end of each leg below each insulated panel, to cover an ankle of a taller rider, to be cut away to fit shorter riders.
